(19) United States
(12) Patent Application Publication
(10) Pub. No.: US 2015/0043201 A1
(43) Pub. Date: Feb. 12, 2015

(54) LAMP INSTALLATION DEVICE

(71) Applicant: SHENZHEN JIAWEI PHOTOVOLTAIC LIGHTING CO., LTD, Shenzhen (CN)

(72) Inventors: Zhiyong LIU, Shenzhen (CN); Ping YAN, Shenzhen (CN)

(73) Assignee: SHENZHEN JIAWEI PHOTOVOLTAIC LIGHTING CO., LTD, Shenzhen (CN)

(21) Appl. No.: 14/024,112

(22) Filed: Sep. 11, 2013

(30) Foreign Application Priority Data
Aug. 8, 2013 (CN) 201320483462.4

(51) Int. Cl. F21V 21/02

(52) U.S. Cl. CPC F21V 21/02
USPC 362/147

(57) ABSTRACT

The present invention relates to lamp installation and fixing field, discloses a lamp installation device used for fixedly installing a lamp into an installing hole in a ceiling or wall, the lamp installation device including a lamp body and a driving power arranged on the lamp body, the lamp installation device further includes a holder arranged in the installing hole, the lamp body and the holder forms a whole by at least one set of elastic sheets. In the present invention the structure of the lamp installation device is simple, the installation of the lamp installation device is convenient and the disassembly is easy, time and effort for the installation and disassembly are reduced, meanwhile, the clasp between the lamp body and holder of the lamp installation device is safe and reliable.

### BACKGROUND OF THE INVENTION

1. Technical Field

The present invention relates to a lamp installation and fixing device, and more particularly, to a lamp installation device.

2. Description of Related Art

At present, a common lamp in the market generally is fixed by screws, however, which takes much time, and installation process of the lamp is very cumbersome and inconvenient. Meanwhile, a ladder is needed and then an operator stands on the ladder to operate on a ceiling for a long operation time, the operation is inconvenient, when the operator stands on the ladder for the long operation time, he or she will take a risk of falling down from the ladder, therefore, the operation will be time-consuming and labor-intensive.

It is an urgent issue that how to design a safe and reliable lamp installation device with simple structure and without screws for fixing, meanwhile, the installation of the lamp installation device should be simple and convenient.

### BRIEF SUMMARY OF THE INVENTION

The object of the present invention is to provide a lamp installation device in order to overcome the problem that the common lamp in the prior art is fixed by screws, the installation process of the lamp is very cumbersome, and the operation is time-consuming and labor-intensive.

The present invention adopts the following technical solutions to solve the technical problem: A lamp installation device used for fixedly installing a lamp into an installing hole in a ceiling or wall, the lamp installation device including a lamp body and a driving power arranged on the lamp body, the lamp installation device further includes a holder arranged in the installing hole, the lamp body and the holder forms a whole by at least one set of elastic sheets.

In an embodiment, two sets of elastic sheets are provided, the sets of elastic sheets include a first set of elastic sheets connected to the lamp body by fasteners and a second set of elastic sheets fixedly connected to the holder. Furthermore, the driving power is clasped and fixed on the lamp body by the first set of elastic sheets.

Furthermore, each elastic sheet of the first set of elastic sheets comprises a clamping end and a connecting end, the clamping end is bended as a C in shape, the clamping ends abut on the top of two sides of the driving power, the connecting end is opposite to the clamping end and vertically bended to form an edgefold.

Furthermore, the edgefold of the connecting end is fixed on surfaces of the lamp body by fasteners.

Furthermore, one end of each elastic sheet of the second set of elastic sheets is bended inwards to form a step engaged with the clamping end, the other end of each elastic sheet of the second set of elastic sheets is vertically bended and fixedly connected to the holder.

In the other embodiment, the set of elastic sheets includes a plurality of elastic sheets fixed on the lamp body, the plurality of elastic sheets are symmetrically arranged on the surfaces of the lamp body.

Furthermore, the lamp body is provided with at least one set of fixing holes matching with the elastic sheets, the elastic sheets are fixed on the fixing holes by fasteners.

Furthermore, the elastic sheet includes an abutting end and a fixing end, the abutting end is bended as a hook in shape, the fixing end opposites the abutting end and is vertically bended to form an edgefold.

Furthermore, the edgefold is fixed on the fixing holes by fasteners.

Comparing with the prior art, in the present invention the set of elastic sheets is provided between the lamp body and holder of the lamp installation device, the lamp body and holder of the lamp installation device are clasped to form a whole by means of the set of elastic sheets, the structure of the lamp installation device is simple, the installation of the lamp installation device is convenient and the disassembly is easy, time and effort for the installation and disassembly are reduced, meanwhile, the clasp between the lamp body and holder of the lamp installation device is safe and reliable.

### BRIEF DESCRIPTION OF THE SEVERAL VIEWS OF THE DRAWINGS

FIG. 1 is a schematic exploded view of a lamp installation device according to a first embodiment of the present invention;

FIG. 2 is a partial enlarged view of a part pointed by A in FIG. 1;

FIG. 3 is a partial enlarged view of a part pointed by B in FIG. 1;

FIG. 4 is a schematic exploded view of a lamp installation device according to a second embodiment of the present invention; and

FIG. 5 is a partial enlarged view of a part pointed by C in FIG. 4.

### DETAILED DESCRIPTION OF THE INVENTION

In order to make clearer the objects, technical solutions and advantages of the invention, the present invention will be explained below in detail with reference to the accompanying drawings and embodiments. It is to be understood that the following description of the embodiments is merely to explain the present invention and is no way intended to limit the invention.

Embodiments of the present invention will be described in detail combining with appended drawings below.

A common lamp in the market generally is fixed on a ceiling or wall by screws, while a holder of the lamp installation device provided in the embodies of the present invention is installed in an installation hole in a ceiling or wall, then a lamp body of the lamp installation device and the holder are fixedly connected by means of elastic sheets, the lamp installation device has a stable structure and can be installed easily.

### A FIRST EMBODIMENT

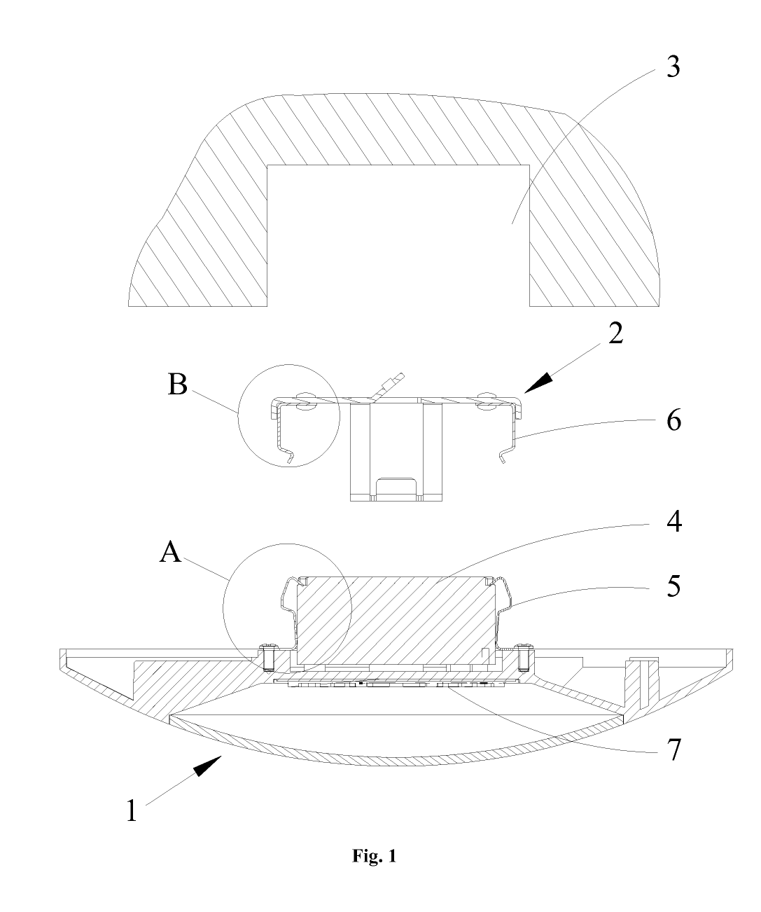

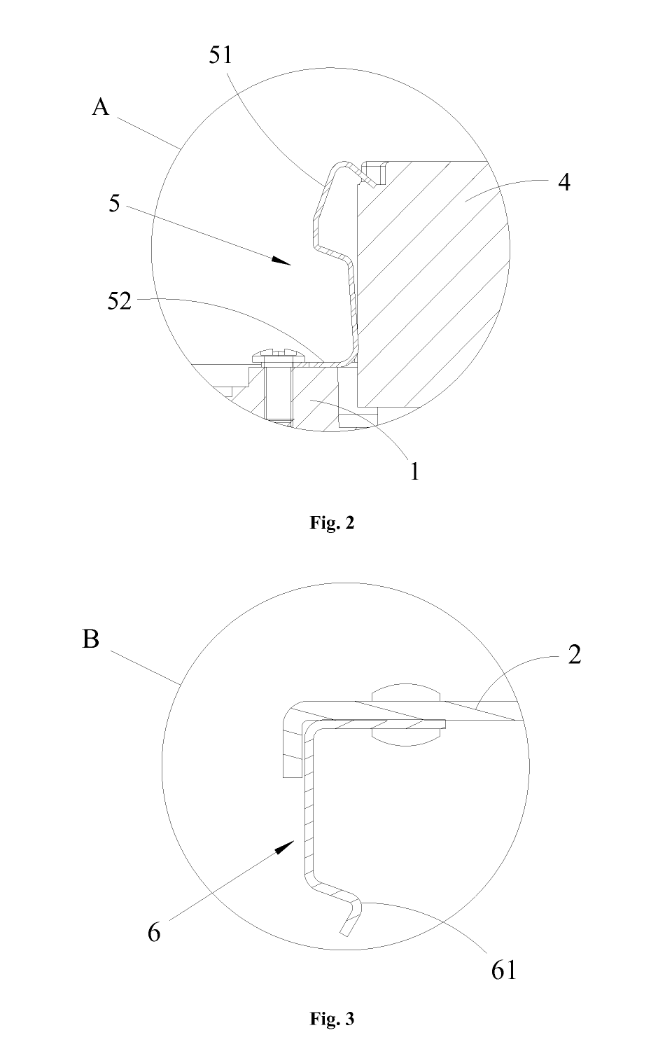

As shown in FIG. 1 to FIG. 3, a preferable embodiment is provided according to the present invention.

A lamp installation device in the embodiment includes a lamp body 1 and a holder 2, the holder 2 is fixedly installed in an installing hole 3 on a ceiling by means of screws, two sides of the holder 2 extends downwards a second set of elastic sheets 6, a middle part of the lamp body 1 is provided with a driving power 4, an LED source 7 is installed between the driving power and the lamp body 1, a first set of elastic sheets 5 extending upwards is fixedly installed on surfaces of the lamp body 1 located at two sides of the driving power 4 by means of fasteners. Meanwhile, edges of two sides of the driving power 4 are clamped by a top end of each elastic sheet of the first set of elastic sheets 5 and fixed on the lamp body 1, thus the lamp body 1 and holder 2 can forms a whole by the clamping between the first set of elastic sheets 5 and the second set of elastic sheets 6.

In the above lamp installation device, the lamp body 1 and holder 2 are matched and installed in the installing hole 3 of the ceiling. The lamp installation device has the advantages as follow:

1). The first set of elastic sheets is adopted. The first set of elastic sheets serves as a link between upper parts and lower parts of the lamp installation device, firstly, the driving power 4 is fixed on the lamp body 1, secondly, an upper end of each sheet of the first set of elastic sheets 5 is engaged with each sheet of the second set of elastic sheets 6 respectively. The structure of each elastic sheet is simple and convenient for production.

2). The second set of elastic sheets is adopted. One end of each sheet of the second set of elastic sheets and the holder 2 fixed in the installing hole 3 of the ceiling are fixed, the other end is used to clamp the first set of elastic sheets 5, thus, during the installation of the lamp installation device, just directly inserting the lamp body 1 with the first set of elastic sheets 5 into the installing hole 3, the lamp body is immediately fixed in the installing hole. The installation is convenient and the disassembly is easy, time and effort for the installation and disassembly are reduced.

3). According to the mechanics principle, the strength of elastic sheets is proportional to the weight of the lamp body 1, therefore, the required hardness of each elastic sheet can be obtained, the elastic sheet with the required hardness can be produced correspondingly, which ensures that an installed entire lamp is stable, safe and reliable.

In the embodiment, each elastic sheet of the first set of elastic sheets 5 includes a clamping end 51 and a connecting end 52, the clamping end 51 is bended as a C in shape, an opening of the clamping end 51 faces the driving power 4, a front end of the clamping end 51 abuts on top edges of the driving power 4, the connecting end 52 is opposite to the clamping end 51 and vertically bended to form an edgefold. The edgefold is contacted with surfaces of the lamp body 1 and fixed on the lamp body 1 by screws, so that the entire first set of sheets 5 is fixed on the surfaces of the lamp body 1, and the driving power 4 is also fixed on the lamp body 1. It is should be understood that, according to the special case and actual requirement, other kind of structure can be used for the first set of elastic sheets 5, the kind of structure is not limited to the embodiment, the edgefold also can be fixed on the lamp body 1 in other connecting manner, such as riveting, weld and so on.

A top end of each elastic sheet of the second set of elastic sheets 6 is vertically bended and fixedly connected to an end of the holder 2 by rivets, the other end of each elastic sheet of the second set of elastic sheets 6 is extended downwards and bended inwards to form a step 61, the step is engaged with the clamping end 51 of each elastic sheet of the first set of elastic sheets 5. It is should be understood that, according to special case and actual requirement, other kind of structure also can be used for the second set of elastic sheets 6, the kind of structure is not limited to the embodiment, also, the second set of elastic sheets 6 and the holder 2 can be connected in other connecting manner, such as riveting, weld and so on.

During the installation of the lamp installation device, firstly, the second set of elastic sheets 6 is fixedly installed on two ends of the holder 2, secondly, the holder 2 is fixedly installed in the installing hole 3 on the ceiling by screws, and then the first set of elastic sheets 5 is fixed on the surfaces of the lamp body 1 located at two sides of the driving power 4. Meanwhile, the front end of the clamping end 51 of each elastic sheet of the first set of elastic sheets 5 abuts on the top edges of the two sides of the driving power 4, therefore, the driving power 4 is fixed on the lamp body 1, then the entire lamp body 1 is inserted into the installing hole 3, thus the clamping end 51 of each elastic sheet of the first set of elastic sheets 5 is engaged with the step 61 of each elastic sheet of the second set of elastic sheets 6 so as to achieve a fixing, and the installation of an entire lamp is finished. Time and effort for the installation and disassembly are reduced.

### A SECOND EMBODIMENT

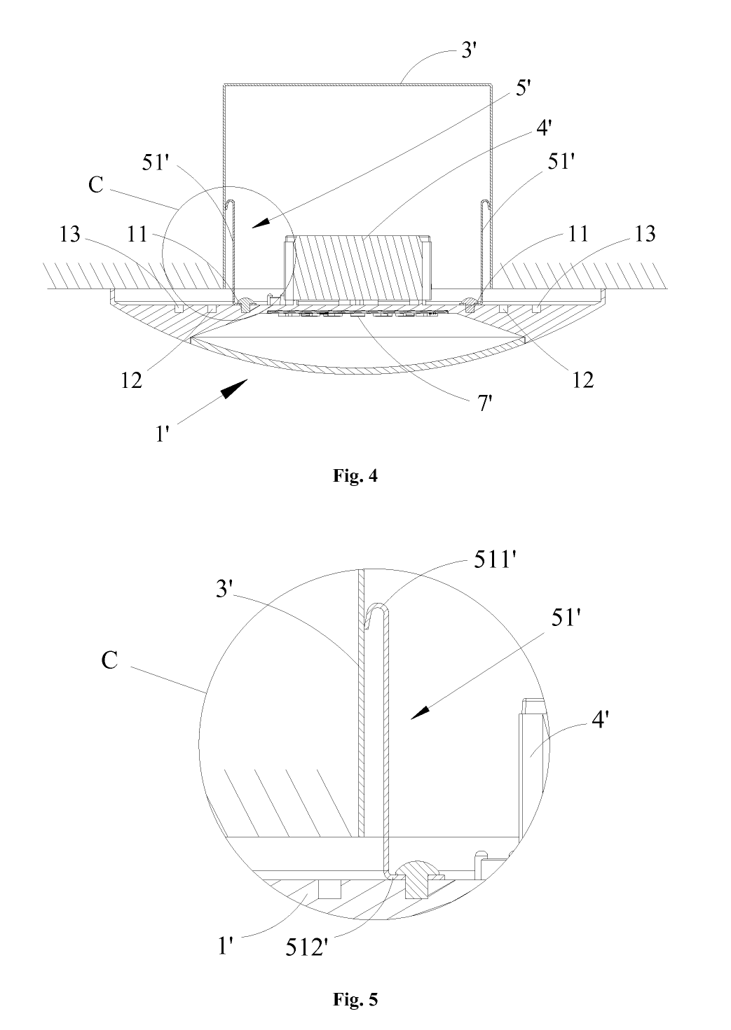

FIG. 4 and FIG. 5 show another preferable embodiment according to the present invention.

The lamp installation device in the embodiment includes a lamp body 1′, a middle part of the lamp body 1′ is provided with a driving power 4′, an LED source 7′ is installed between the driving power 4′ and the lamp body 1′, a set of elastic sheets 5′ extending upwards is fixedly on the lamp body 1′, the set of elastic sheets is inserted in a lamp holder 3′, thus the set of elastic sheets is firmly abuts on inner walls of the lamp holder 3′ and the lamp body 1′ is firmly installed in the lamp holder 3′.

In particular, the set of elastic sheets 5′ includes three sheets 51′ symmetrically arranged on the surfaces of the lamp body 1′, all the included angles between each sheet are 120 ° , the driving power 4′ is surrounded by the elastic sheets, a lower end of each elastic sheet is fixed on the lamp body 1′, and an upper end of each elastic sheet extends upwards. During the installation of the lamp installation device, the set of elastic sheets 5′ is just inserted into the lamp holder 3′, the upper end of each elastic sheet 51′ can firmly abut on the inner walls of the lamp holder 3′, thus an entire lamp is firmly installed in the lamp holder 3′. It should be understood that, according to the special case and actual requirement, more elastic sheets 51′ can be used for the set of elastic sheets 5′.

The elastic sheet 51′ includes an abutting end 511′ and a fixing end 512′, the abutting end 511′ is bended outwards as a hook in shape, the fixing end 512′ opposites the abutting end 511′ and is vertically bended to form an edgefold, the fixing end 512′ is fixed on the lamp body 1′ by screws through the edgefold, the abutting end 511′ is inserted in a cavity of the lamp holder 3′ and abuts on the cavity walls of the lamp holder 3′, thus a firmly fixing is formed.

Sets of fixing holes for fixing the elastic sheets are defined in the surfaces of the lamp body 1′ around the driving power 4′, three fixing holes of the sets of fixing holes are symmetrically arranged with an included angle 120° between themselves. The set of fixing holes includes first sets of fixing holes 11, 12, 13 which match with the lamp holders with sizes 4 inch, 5 inch and 6 inch respectively. During the installation of the lamp installation device, just fixedly install each elastic sheet 51′ into corresponding set of fixing hole, each elastic sheet will match with the lamp holders with different sizes. It should be understood that, according to the special case and actual requirement, more fixing holes can be defined so as to match with lamp holders with different sizes, which provides a user more selections, that is, a lamp body can match with multiple lamp holders with different sizes, thus the cost of the installation is reduced, the installation operation is simple, and the structure of the lamp installation device is stable and reliable.

During the installation of the lamp installation device, after the lamp body 1′ is assembled, the edgefold of the lower end of the elastic sheet 51′ is fixedly installed in the corresponding fixing hole, then the lamp body 1′ with sets of elastic sheets 5′ is directly inserted into the lamp holder 3′ with a corresponding size, correspondingly, the abutting end 511′ of each elastic sheet of the sets of elastic sheets 5′ firmly abuts on the inner walls of the lamp holder 3′, thus the fixing and installation of the entire lamp is finished.

The present invention has been further detailed in the above descriptions with reference to the preferred embodiments; however, it shall not be construed that implementations of the present invention are only limited to these descriptions. Many simple deductions or replacements may further be made by those of ordinary skill in the art without departing from the conception of the present invention, and all of the deductions or replacements shall be considered to be covered within the protection scope of the present invention.

1. A lamp installation device used for fixedly installing a lamp into an installing hole in a ceiling or wall, the lamp installation device comprising a lamp body and a driving power arranged on the lamp body, wherein the lamp installation device further comprises a holder arranged in the installing hole, and the lamp body and the holder forms a whole by at least one set of elastic sheets.

2. The lamp installation device of claim 1, wherein two sets of elastic sheets are provided, the two sets of elastic sheets comprise a first set of elastic sheets connected to the lamp body by fasteners and a second set of elastic sheets fixedly connected to the holder.

3. The lamp installation device of claim 2, wherein the driving power is clasped and fixed on the lamp body by the first set of elastic sheets.

4. The lamp installation device of claim 3, wherein each elastic sheet of the first set of elastic sheets comprises a clamping end and a connecting end, the clamping end is bended as a C in shape, the clamping ends abut on the top of two sides of the driving power, and the connecting end is opposite to the clamping end and vertically bended to form an edgefold.

5. The lamp installation device of claim 4, wherein the edgefold of the connecting end is fixed on surfaces of the lamp body by fasteners.

6. The lamp installation device of claim 4, wherein one end of each elastic sheet of the second set of elastic sheets is bended inwards to form a step engaged with the clamping end, and the other end of each elastic sheet of the second set of elastic sheets is vertically bended and fixedly connected to the holder.

7. The lamp installation device of claim 1, wherein the set of elastic sheets comprises a plurality of elastic sheets fixed on the lamp body, and the plurality of elastic sheets are symmetrically arranged on the surfaces of the lamp body.

8. The lamp installation device of claim 7, wherein the lamp body is provided with at least one set of fixing holes matching with the elastic sheets, and the elastic sheets are fixed on the fixing holes by fasteners.

9. The lamp installation device of claim 8, wherein the elastic sheet includes an abutting end and a fixing end, the abutting end is bended as a hook in shape, and the fixing end opposites the abutting end and is vertically bended to form an edgefold.

10. The lamp installation device of claim 9, wherein the edgefold is fixed on the fixing holes by fasteners.
